(19) United States
(12) Patent Application Publication
(10) Pub. No.: US 2010/0158512 A1
(43) Pub. Date: Jun. 24, 2010

(54) Centrally Managed, Self-Survivable Wavelength Division Multiplexed Passive Optical Network

(75) Inventors: Gee-Kung Chang, Smyrna, GA (US); Arshad Chowdhury, Atlanta, GA (US); Hung-Chang Chien, Atlanta, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Georgia Tech Research Corporation, Atlanta, GA (US)

(21) Appl. No.: 12/582,550

(22) Filed: Oct. 20, 2009

Related U.S. Application Data
(60) Provisional application No. 61/106,759, filed on Oct. 20, 2008.

(51) Int. Cl. H04J 14/02

(52) U.S. Cl. 398/7

(57) ABSTRACT

A centrally-managed, colorless, bi-directional wavelength division multiplexed passive optical network (WDM-PON) architecture. The WDM-PON architecture is self-survivable, and can protect network failures in, for example, distribution/feeder fiber, remote node and laser failure. The WDM-PON architecture requires only N-wavelength channels for N optical network units.

### CROSS REFERENCE TO RELATED APPLICATION

This application claims benefit under 35 USC §119(e) of U.S. Provisional Patent Application Ser. No. 61/106,759 filed 20 Oct. 2008, which application is hereby incorporated fully by reference.

### BACKGROUND OF THE INVENTION

1. Field of the Invention

The present invention relates generally to improved fiber-optic communications. More specifically, the present invention is a self-survival wavelength division multiplexed passive optical network architecture with centralized protection switching and colorless optical network units using optical carrier suppression, separation techniques and wavelength sharing schemes.

2. Description of the Related Art

Fiber-optic communication is a method of transmitting information from one place to another by sending pulses of light through an optical fiber. The light forms an electromagnetic carrier wave that is modulated to carry information. Because of its advantages over electrical transmission, optical fibers have largely replaced copper wire communications in core networks in the developed world.

A passive optical network (PON) is a point-to-multipoint, fiber to the premises network architecture in which optical splitters are used to enable a single optical fiber to serve multiple premises. A PON generally includes an optical line terminal (OLT) at the service provider's central office (CO), and a number of optical network units (ONUs) near end users. Down-stream signals are broadcast to each location sharing a single fiber. Encryption is used to prevent eavesdropping. Up-stream signals are combined using a multiple access protocol, usually time division multiple access (TDMA). The OLTs “range” the ONUs in order to provide time slot assignments for up-stream communication. A PON configuration reduces the amount of fiber and central office equipment required compared with point-to-point architectures.

Wavelength-division multiplexing (WDM) is a technology that multiplexes multiple optical carrier signals on a single optical fiber by using different wavelengths (colors) of laser light to carry different signals. This allows for a multiplication in capacity, in addition to enabling bidirectional communications over one strand of fiber.

Modern fiber-optic communication systems generally include an optical transmitter to convert an electrical signal into an optical signal to send into the optical fiber, a cable containing bundles of multiple optical fibers that is routed through underground conduits and buildings, multiple kinds of amplifiers, and an optical receiver to recover the signal as an electrical signal. Thus, the process of communicating using fiber-optics generally involves creating the optical signal involving the use of a transmitter, relaying the signal along the fiber, ensuring the signal does not become too distorted or weak, receiving the optical signal, and converting it into an electrical signal.

The growth of the Internet is exponential worldwide. The type of transmitted information has changed from voice to multimedia and the amount of information is always increasing. The end users are attracted by the numerous and versatile emerging applications, such as high-definition videoconferencing, video-on-demand, high-definition television, e-learning, and high-quality audio transmission.

To deliver these integrated services effectively and at affordable prices, providers strive to implement new technologies. The use of WDM techniques in PONs appears to be a promising candidate to solve the bottleneck problem of broadband access for business and residential customers. WDM-PON is an attractive method to deliver high bandwidth services to the premises. This technology has the potential for large capacity, easy management, protocol transparency and upgradeability.

The wavelength division multiplexed passive optical network (WDM-PON) is being considered as the ultimate solution to meet the ever increasing bandwidth demand with high quality of services (QoS) for the next-generation broadband access networks. One of the key requirements for an advantageous WDM-PON system is that it has to be cost-effect both from the service provider's and the user's perspective.

As per channel data rate in future WDM-PON access networks are envisioned to 10 Gbps or more, the network reliability and survivability of such high-speed networks need to be addressed ever more seriously. Several implementations have been proposed to realize protection schemes in WDM-PON networks. Some proposed protection schemes are distributed in nature, where protection switching is placed in each ONU. In contrast, other proposed protection schemes perform centralized protection switching at CO. However, such systems utilize wavelength-dependent ONUs comprising active optical elements (laser sources), which are not desirable in WDM passive networks. In another proposed protection scheme, a centralized system with colorless ONUs for uni-directional WDM-PON is used, which uses two dedicated feeder fiber pairs, one for up-stream and one for down-stream channels. Yet, none of these proposed protection schemes in WDM-PON networks support any transmitter laser failure.

Therefore, a need yet exists for a centrally controlled self-protected, bi-directional WDM-PON architecture. It is to the provision of such systems that the present invention is primarily directed.

### BRIEF SUMMARY OF THE INVENTION

Briefly described, in an exemplary form, the present invention comprises a fault tolerant wavelength division multiplexed passive optical system. The system can comprise a plurality of light sources at a central office enabled to distribute a plurality of wavelength channels, at least two remote nodes—at least one working remote node and at least one protection remote node provided in communication with the plurality of light sources at the central office, and a plurality of wavelength independent optical network units provided in communication with the at least one working remote node and the at least one protection remote node, wherein at least one of the plurality of wavelength independent optical network units can receive one or more of the plurality of wavelength channels from the protection remote node after detection of a failure event, and wherein the number of the plurality of light sources is substantially equal to the number of the plurality of wavelength independent optical network units.

The number of the plurality of light sources can be equivalent to the number of the plurality of wavelength independent optical network units.

The failure event can comprise, for example, a feeder failure, a distribution failure, a remote node failure, or a light source failure.

The plurality of wavelength channels can be distributed according to a clockwise sharing scheme.

Each of the plurality of wavelength channels can comprise of two sub-wavelength channels, and each of the sub-wavelength channels can be generated using optical carrier suppression.

The plurality of light sources can provide both an up-stream signal and a down-stream signal.

In another exemplary embodiment, the present invention is a self-survival WDM-PON architecture with centralized protection switching and colorless ONUs using optical carrier suppression, separation techniques and wavelength sharing schemes.

The present invention uses optical a carrier suppression (OCS) technique and a clock-wise wavelength assignment scheme to provide both up-stream and down-stream carrier signals for N number of ONUs using only N number of laser diodes at the CO, both in working and protection mode. The present self-survivable protection scheme supports failures at feeder fiber, distribution fiber, array waveguide grating (AWG) failure at remote node, and laser failure at CO.

In another exemplary embodiment, the present invention comprises a centrally protected, bi-directional, colorless WDM-PON that supports protection of feeder and distribution fiber failure, AWG failure at remote nodes (RNs), and laser failure at CO. A clock-wise wavelength sharing scheme of N-wavelength channels and optical carrier suppression techniques are used to provide the centralized US and DS carrier signal for N ONUs in both working and protection modes. The present invention can deliver error-free transmission of both 10 Gbps DS and US can be achieved with less than 0.7 dB and 1.2 dB of power penalty both in working and protection modes after 20 km bi-directional SMF-28 transmission.

Thus, it is an object of the present invention to provide a centrally-managed, self-survivable wavelength division multiplexed passive optical network.

It is another object of the present invention to provide a system of protection for both fiber failure and transmitter failure. Fiber failure protection covers feeder fiber failure, distribution fiber failure and remote node failure. Transmitter failure covers up-stream and down-stream transmitter failure.

Yet another object of the present invention is to provide a centralized protection switching mechanism where the optical protection switch elements are placed and controlled at the central office, thus simplifying the optical network unit design.

It is a further object of the present invention to provide optical carrier suppression and separation techniques at the central office to generate both the up-stream and the down-stream carrier signals for each optical network unit.

It is another object of the present invention to design a system with optimum performance and cost structures, including requiring only N laser sources at the central office to support both up-stream and down-stream carrier signals for N number of optical network units both in the working mode and the protection mode of operation.

It is yet another object of the present invention to provide a system using wavelength independent (colorless) optical network units.

It is a further object of the present invention to provide a system utilizing tunable laser sources at the central office to protect multiple transmitter failure for both up-stream and down-stream signals.

These and other objects, features and advantages of the present invention will become more apparent upon reading the following specification.

### BRIEF DESCRIPTION OF THE FIGURES

FIG. 1 illustrates a preferred embodiment of the present invention.

FIG. 2 illustrates a preferred transmission response of the array waveguide grating and the interleaver filter, according to a preferred embodiment of the present invention.

FIGS. 3A-3C illustrates preferred network protection switching after a distribution fiber failure, according to a preferred embodiment of the present invention.

FIG. 4 illustrate an experimental setup providing a centralized light source and protection embodiment of the present invention for two ONUs.

FIGS. 5a-5d shows the optical spectra of various signals at various stages of the setup of FIG. 4.

FIG. 6 illustrates the protection switching and recovery time of the setup of FIG. 4.

FIG. 7 shows the bit-error-rate measurements and optical Eye diagram at various transmission points at 10 Gbps down-stream of the setup of FIG. 4.

FIG. 8 shows the bit-error-rate measurements and optical Eye diagram at various transmission points at 10 Gbps up-stream of the setup of FIG. 4.

### DETAILED DESCRIPTION OF PREFERRED EMBODIMENTS

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

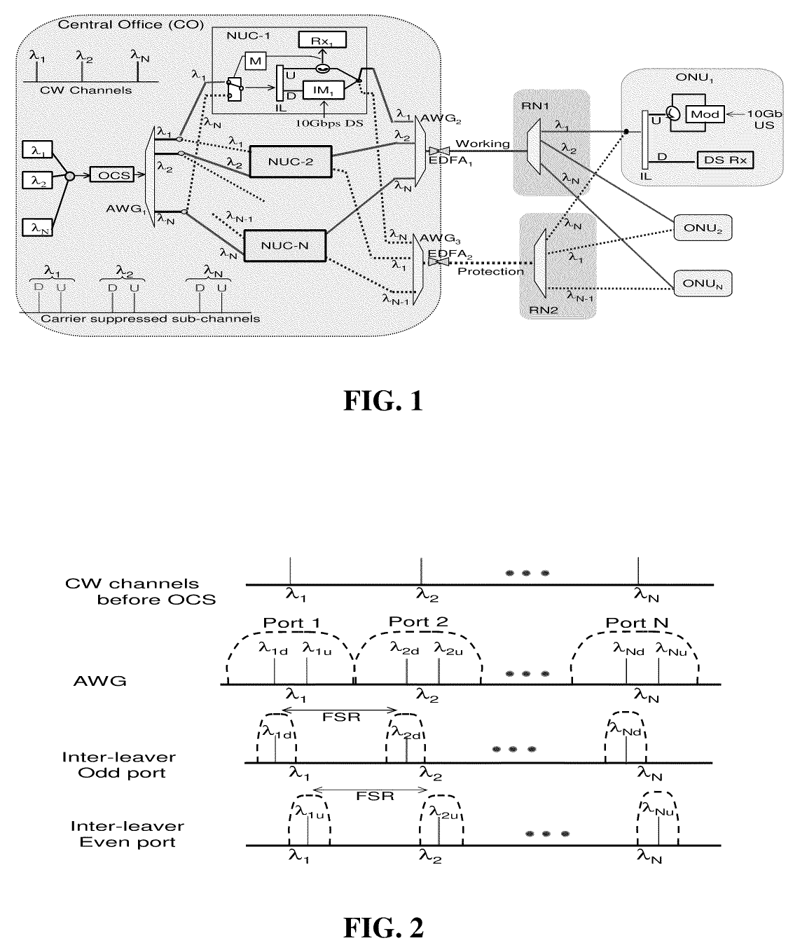

In a exemplary embodiment of the present invention, as shown in FIG. 1, the architecture of the self-survivable WDM-PON network providing centralized light sources and protection scheme is illustrated for N ONUs in a bi-directional transmission system. At the CO, N wavelength channels (λ₁ . . . λ_{N}) are shown, used to provide both the down-stream (DS) and up-stream (US) light sources for the N ONUs.

For each λ_{I} (I=1 . . . N), two sub-wavelength channels (λ_{Id} and λ_{Iu}) are generated using an optical carrier suppression (OCS) technique. However, only one OCS unit need be used for N-wavelength channels to generate their respective sub-wavelength channels. A clock-wise wavelength sharing scheme among the ONUs is shown to provide centralized light sources for US and DS directions both in the working and protecting mode, as shown in TABLE 1.

TABLE 1

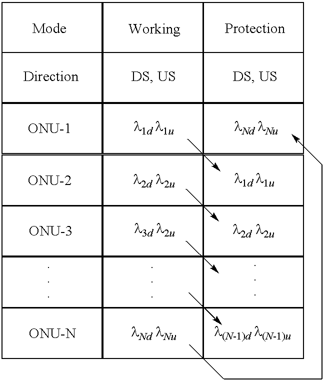

In the normal working mode, the sub-wavelength channels λ_{Id} and λ_{Iu} generated at wavelength λ_{I} are used to provide both DS and US channels, respectively, for the I-th optical network unit (ONU_{I}) for I=1 . . . N. However, in the protection mode, the ONU_{I} is served by the wavelength channel λ_{I-1} (i.e., λ_{(I-1)d} and λ_{(I-1)u)} for I=2 . . . N and for I=1, the ONU₁ is served by the wavelength channel λ_{N} (i.e., λ_{Nd} and λ_{Nu}).

After the OCS, the working and protection channels designated to the ONU_{I} are fed into respective Network Unit Controllers (NUC-I) using an array waveguide grating (AWG₁) filter and 3 dB splitters. The NUC-I performs protection switching and transceiver operations for ONU_{I}. At NUC-I, an optical switch is used to select the appropriate wavelength channel based on the mode of operation (working or protection) of ONU_{I}, which is determined by the optical power monitor (M_{I}). An optical filter with appropriate bandwidth and center wavelength can be used to separate the DS and US carriers. In an exemplary embodiment, an interleaver filter (IL) is used.

FIG. 2 shows the transmission response of the AWG and the odd and event port of the optical interleaver filter. The free spectral range (FSR) of the interleaver odd and even ports allow the separation of the DS and US channels assigned to any particular ONU both in working mode and protection mode. Two array waveguide grating filters AWG₂ and AWG₃ are used to connect the NUC-I to the working and protection feeder fiber, respectively. The port assignment of AWG₂ and AWG₃ to the NUC-I guarantees the appropriate selection of working or protection channel to the associated feeder fiber.

At the remote nodes (RN), a pair of AWGs are used to distribute the DS and US channels both in working mode (RN₁) and protection mode (RN₂). Again, the port connectivity between the AWG at the remote node and the ONU_{I} guarantees the appropriate selection of working or protection wavelength to the associated distribution fiber.

In normal working mode, all the wavelength channels are traverse through the AWG₂ and RN₁. However, any signal loss due to feeder/distribution fiber failure, RN₁ failure or working laser failure detected by the monitor M at NUC-I, immediately set the optical switch in protection state. The corresponding ONU_{I} is then served by the protection wavelength through protection fiber and RN₂. The selection of working or protection mode of ONU_{I} is completely independent of the operation mode of other ONUs.

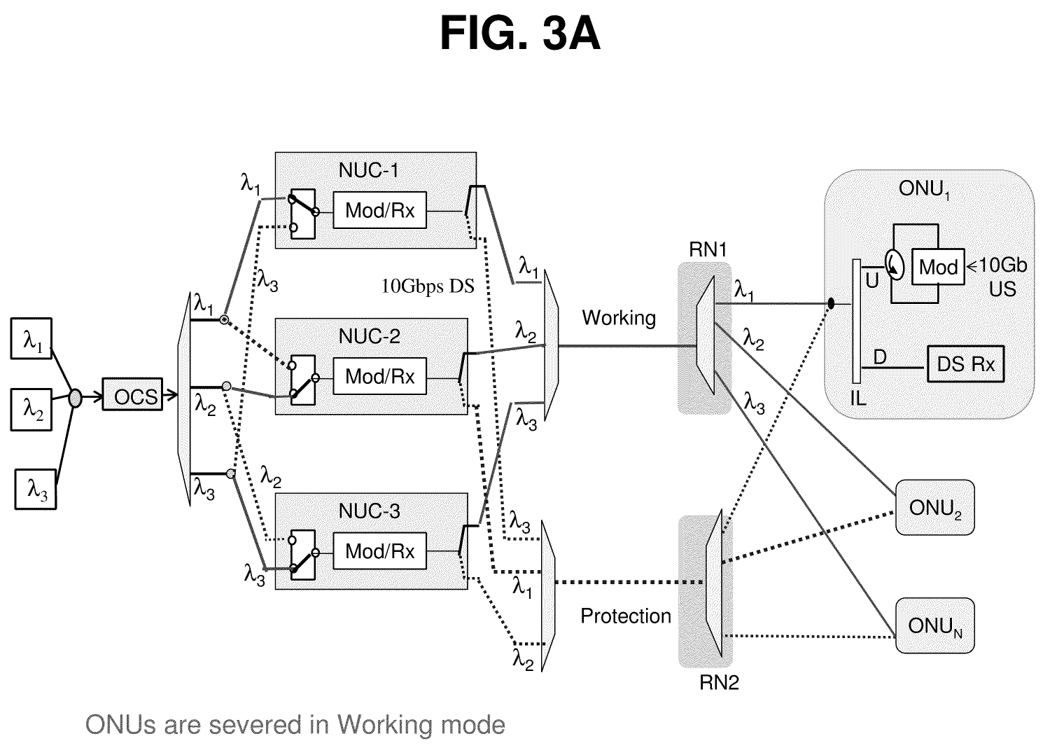

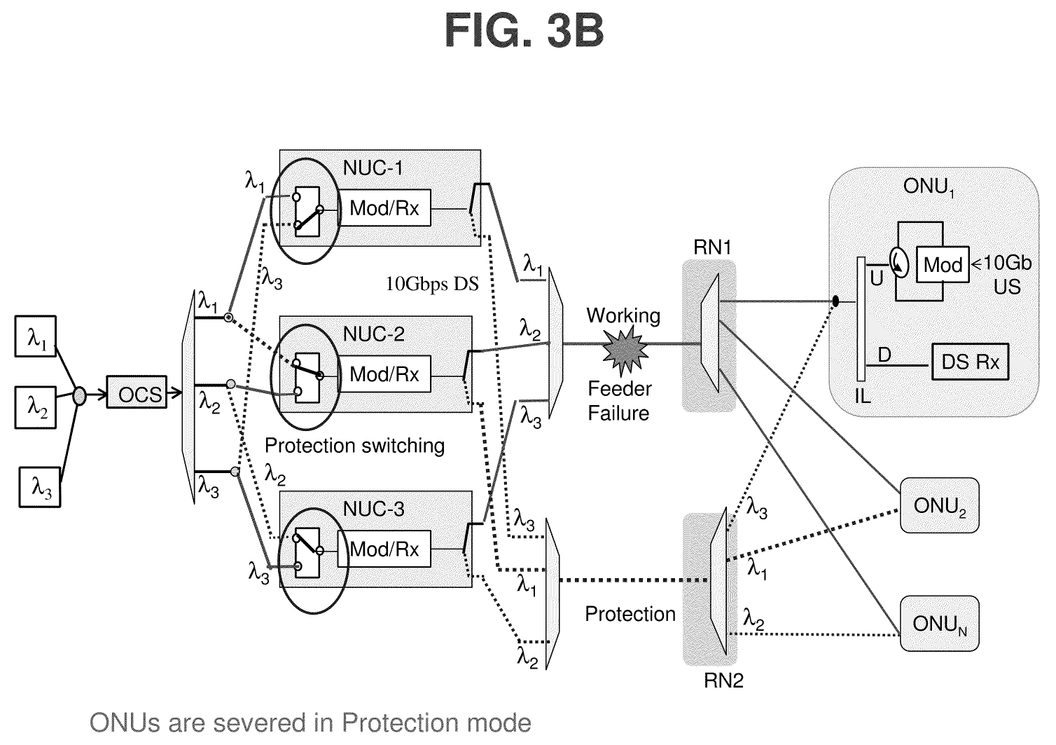

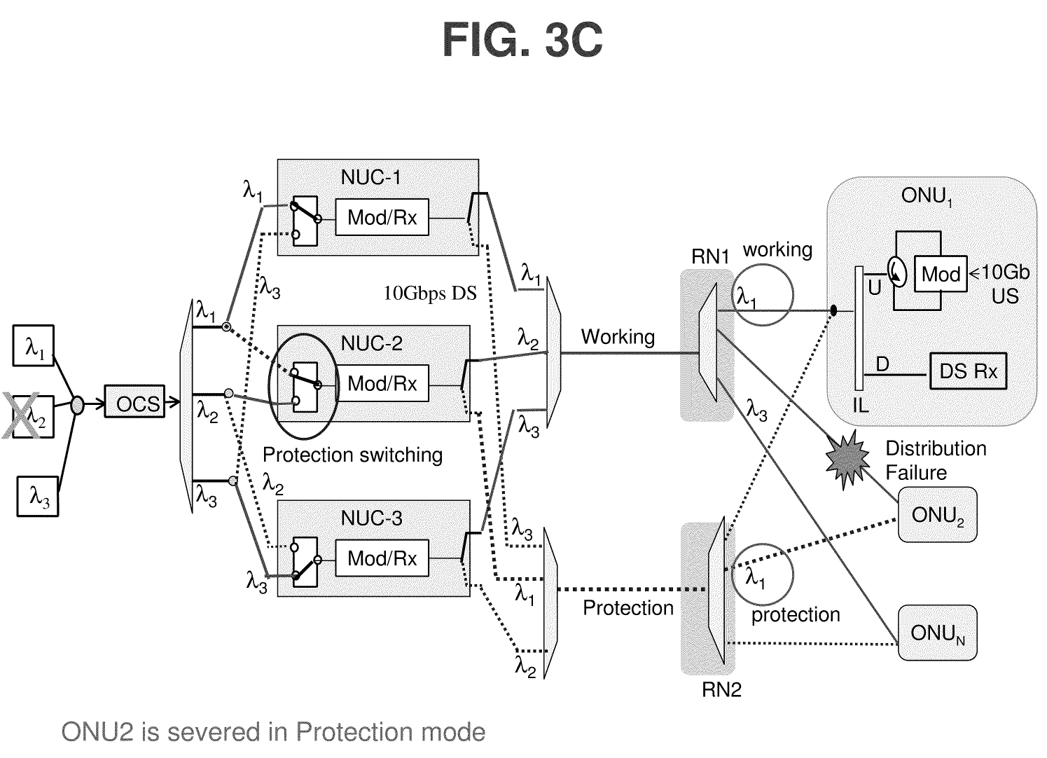

FIG. 3A illustrates a preferred protection switching scenario, with no failure, according to a preferred embodiment of the present invention. FIG. 3B illustrates a preferred protection switching scenario, with feeder failure, according to a preferred embodiment of the present invention. FIG. 3C illustrates a preferred protection switching scenario, with distribution fiber failure or laser failure, according to a preferred embodiment of the present invention.

For example, taking FIG. 3C with reference only to the fiber failure, it shows an example of wavelength assignment both in the working and the protection fiber after a distribution fiber cut occurred at ONU₂. Since the working and protection wavelengths use two disjoint paths, there is no problem sharing the same wavelength (e.g. λ₁) for two ONUs (e.g ONU₁ and ONU₂) simultaneously. Two bi-directional amplifiers, EDFA₁ and EDFA₂, are placed before AWG₂ and AWG₃ at the CO. The amplification in the DS direction compensates for the insertion losses at the CO, while amplification in the opposite direction performs pre-amplification for the US channels.

In regard to the system power budget from EDFA₁ to ONU, in one example, each channel might traverse about 20 km of SMF-28 (0.2 dB/km), one AWG at RN (4 dB), one couple (3 dB), one interleaver (1 dB) and one circulator (1 dB). Thus, overall power loss of the DS channel is about 13 dB, and for the US channel, the loss is about 30 dB (including a 4 dB modulator loss at ONU).

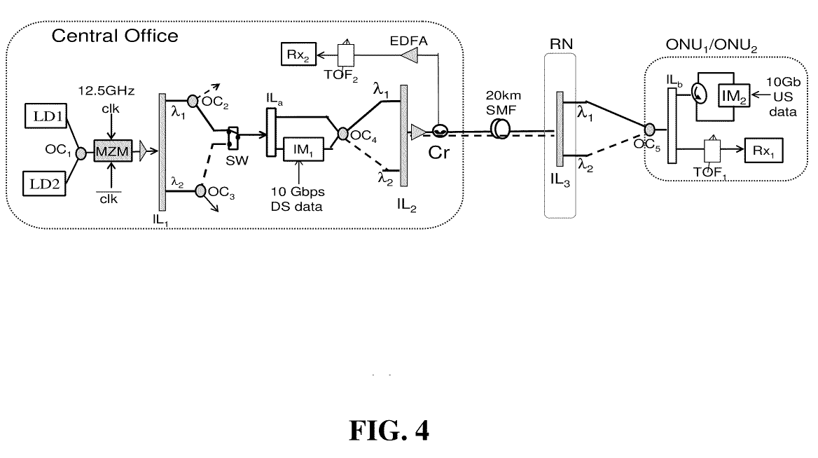

FIG. 4 shows another exemplary embodiment of the present invention. At the CO, two 100 GHz spaced carrier lightwaves (CWs) at 1541.45 nm (λ₁) and 1542.24 nm (λ₂) wavelengths provide the US and DS carrier signals for ONU₁ and ONU₂ both in working and protection mode. The CW signals are injected to a dual-drive LiNbO₃ Mach-Zehnder modulator (MZM) with Vπ of 3.0V. The modulator is driven by a pair of 12.5 GHz complementary RF sinusoidal clock signals. Once the MZM is biased at a transmission null point, the original optical carrier of the injected CW signals are suppressed and two pairs of sub-wavelength channels (λ_{1d}, λ₁ᵤ) and (λ_{2d}, λ₂ᵤ) are generated.

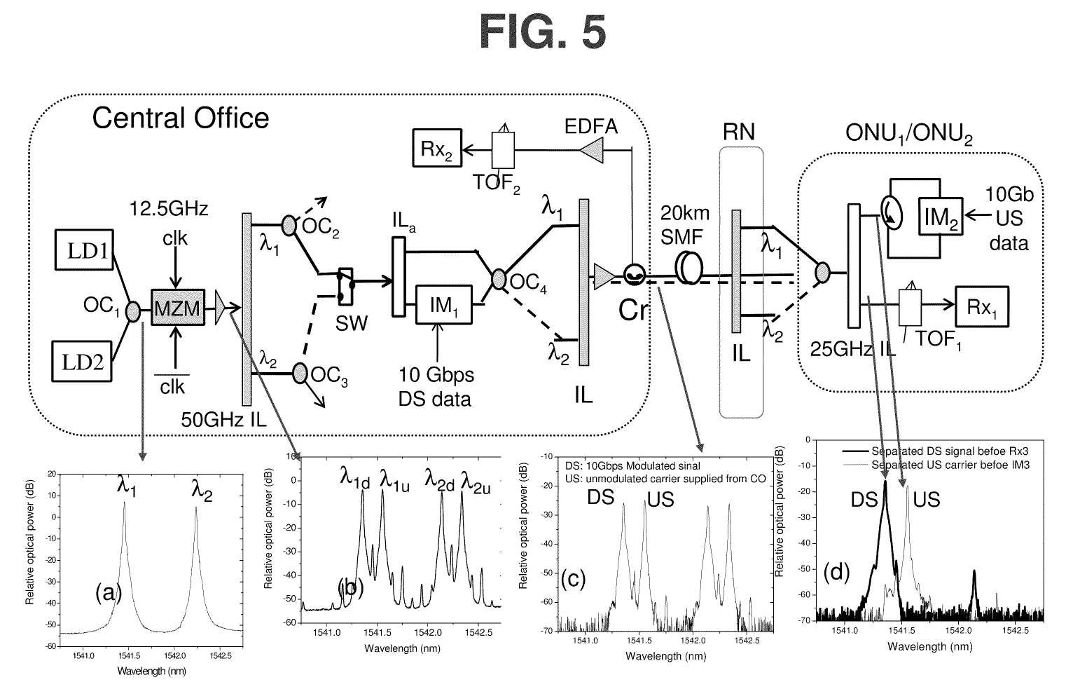

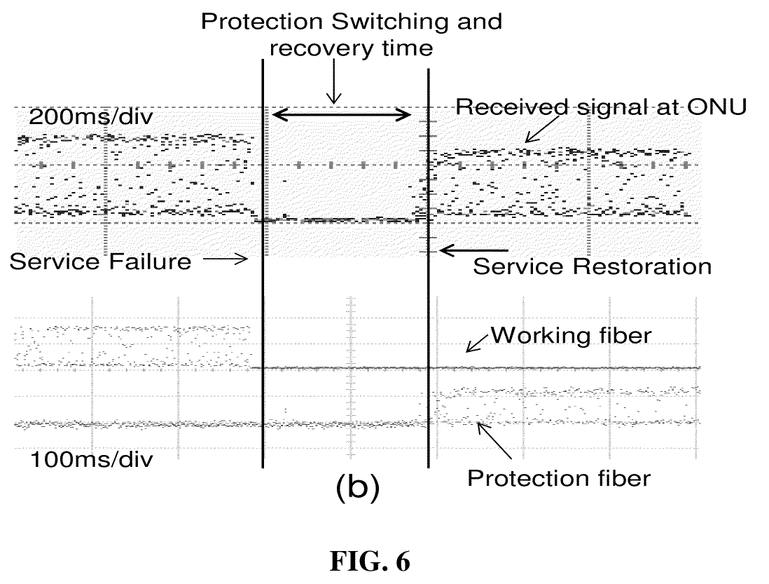

FIGS. 5 and 6 show the optical spectra before and after the optical carrier suppression. The separation between the two sub-channels at each wavelength is 25 GHz, and a carrier suppression ratio of over 30 dB is achieved. An optical interleaver filter (ILₐ) with 25 GHz channel spacing is used to separate the US and DS sub-channels before modulation at the CO and, 100 GHz spaced interleaver filters (IL₁, IL₂, IL₃) are used to separate distinct wavelength channels λ₁ and λ₂ at the CO and RN.

A 2×1 electromechanical optical switch (SW) is used as a protection switch. The switching characteristics are shown in FIG. 6. The transmission distances between the CO and the ONU is 20 km (SMF-28). Each DS and US channel carries 10 Gbps data with a PRBS word length of 2³¹⁻¹. FIG. 5(c) shows the optical spectra of the 10 Gbps DS signals and the unmodulated US carrier signals and FIG. 5(d) shows the separated US and DS channels at the ONU. The insertion loss at the CO is compensated by placing an additional optical amplifier after IL₂. The lunching power per wavelength channel is set to 3 dBm in the DS direction. The channel spacing of IL₃ at the ONU is 50 GHz and the 3 dB bandwidth of the TOF is 0.21 nm. A commercially available 10 Gbps PIN receiver was used to receive both the DS and US data at the ONU and the CO.

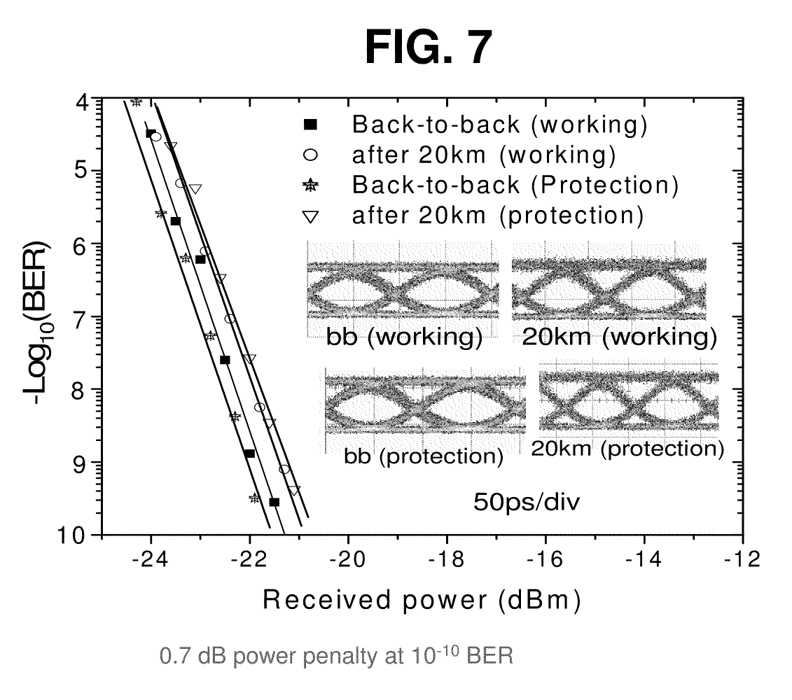

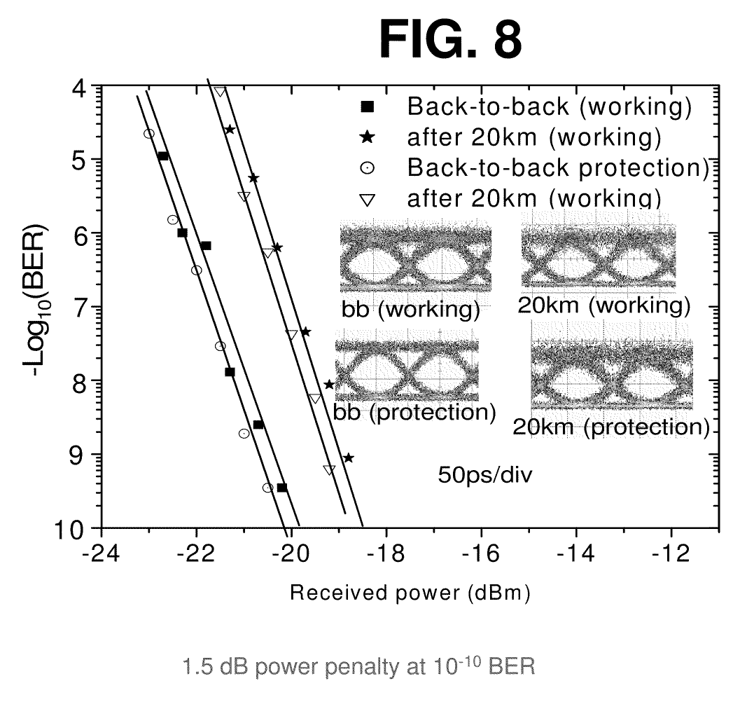

FIGS. 7 and 8 show the bit-error-rate (BER) and the eye diagrams of the DS and US signals. The eyes are wide open with good extinction ratio. At 10⁻¹⁰ BER, the power penalty of the 10 Gbps DS and US channel is less of 0.7 dB and 1.2 dB, respectively, after the 20 km bi-directional transmission both in working and protection modes. The power penalties are mainly due to the fiber chromatic dispersion and cascaded filtering effects at the CO, the RN and the ONU, and unwanted reflections at the circulators. Again, the US transmission suffers an additional 1.5 dB power penalty compared to the DS. This could be due to the optical signal-to-noise ratio (OSNR) degradation of the US carrier signal, which has already transmitted 20 km down-stream from the CO before modulated at the ONU.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

We claim:

1. A fault tolerant wavelength division multiplexed passive optical system comprising:
a plurality of light sources at a central office (CO) enabled to distribute a plurality of wavelength channels;
at least two remote nodes (RNs), at least one working RN and at least one protection RN provided in communication with the plurality of light sources at the CO; and
a plurality of wavelength independent optical network units (ONUs) provided in communication with the at least one working RN and the at least one protection RN;
wherein at least one of the plurality of wavelength independent ONUs can receive one or more of the plurality of wavelength channels from the protection RN after detection of a failure event; and
wherein the number of the plurality of light sources is substantially equal to the number of the plurality of wavelength independent ONUs.

2. The fault tolerant wavelength division multiplexed passive optical system of claim 1, wherein the number of the plurality of light sources is equivalent to the number of the plurality of wavelength independent ONUs.

3. The fault tolerant wavelength division multiplexed passive optical system of claim 1, wherein the failure event comprises a feeder failure, a distribution failure, a RN failure, or light source failure.

4. The fault tolerant wavelength division multiplexed passive optical system of claim 1, wherein the plurality of wavelength channels are distributed according to a clockwise sharing scheme.

5. The fault tolerant wavelength division multiplexed passive optical system of claim 1, wherein each of the plurality of wavelength channels is comprised of two sub-wavelength channels and each of the sub-wavelength channels is generated using optical carrier suppression (OCS).

6. The fault tolerant wavelength division multiplexed passive optical system of claim 1, wherein the plurality of light sources provide both an up-stream signal and a down-stream signal.
